(19) United States
(12) Patent Application Publication
(10) Pub. No.: US 2022/0090364 A1
(43) Pub. Date: Mar. 24, 2022

(54) FITTING CONNECTING PIECE

(71) Applicant: OBLAMATIK AG, Chur (CH)

(72) Inventors: Daniel KNUPFER, Trimmis (CH); Roland OBRIST, Scharans (CH)

(73) Assignee: OBLAMATIK AG, Chur (CH)

(21) Appl. No.: 17/420,925

(22) PCT Filed: Jan. 22, 2019
(86) PCT No.: PCT/EP2019/051432

§ 371 Date: Jul. 6, 2021

(51) Int. Cl. E03C 1/02; F16B 9/00

(52) U.S. Cl. CPC E03C 1/023; F16B 9/058

(57) ABSTRACT

A fitting connecting piece having a main body with pipe unions for water conduits and a main body area with mating surfaces for a functional unit where each pipe union is connected to one allocated port in a mating surface through channels inside the main body is disclosed. A functional unit can be mounted on the main body area with the mating surfaces and the functional unit having ports arranged in a manner complementary to the mating surfaces, characterized in accordance with the invention in that the pipe unions are mounted movably on, in or on the main body. A corresponding fitting connecting piece for sanitary installations is also disclosed.

The present invention relates to a fitting connecting piece. In sanitary engineering, this term is understood to mean an object for which the following designations are also commonly used with a similar or synonymous meaning: Basic unit, connection unit or connection body. The term “flush-mounted installation body” is also used because this object is usually installed under the plaster of a wall (so that no water pipes and connections are exposed) and serves as the basis for a functional unit or sanitary fitting that can be mounted on it. The specific term “fitting connecting piece” best describes the object of the present invention, while the other terms are sometimes not precise definitions and sometimes leave open whether the housing for receiving the fitting connecting piece and functional unit or the mounting box with mounting device for flush-mounted installation are also counted. A fitting connecting piece can be considered as the core of a basic unit.

A fitting connecting piece comprises a main body and has pipe unions for water lines and is provided inside the main body with bores or channels through which each pipe union is connected to a respective associated opening in a mating surface on the main body of the fitting connecting piece. A functional unit with corresponding, complementarily arranged openings can be mounted on the main body area with the mating surfaces.

The functional units, which can be mounted on the fitting connecting piece, usually comprise sanitary valves, in particular mixing valves, for mixing, for example, water from the cold water connection and the hot water connection of the fitting connecting piece in a certain ratio and for discharging the mixed water at a desired mixing temperature via at least one connection of the fitting connecting piece. The functional units can be operated manually by a lever (single-lever mixer), or by a thermostat, or via an electronic control element by a motorized drive.

Fitting connecting pieces have at least three pipe unions, namely for cold water and hot water, as well as for at least one mixed water outlet. Often there are two mixed water outlets, because fitting connecting pieces are often installed in the bathroom, where in a shower the outlet of the mixed water can be selected via the overhead shower and/or the hand shower, or in a bathtub, where the bathtub fitting can be used to select between the bathtub inlet and a showerhead. The shower or bathtub fitting with the functional unit is mounted on the fitting connecting piece installed in the wall.

EP 1 382 757 B1 describes an installation device for sanitary elements. For a cylindrical flush-mounted box of a sanitary fitting, a flange ring is proposed which is axially adjustable, e.g. via a screw thread, so that the distance between the flange ring and the front edge of the flush-mounted box can be adapted to the thickness of the wall. As can also be seen from the figures of EP 1 382 757 B1, the fitting connecting piece accommodated in the flush-mounted box has four radial connections for water pipes arranged at right angles to one another.

DE 10 2004 040 084 B4 describes a sanitary flush-mounted fitting having a connection body. Here, too, an adjustable fastening ring is provided in order to be able to precisely adjust the installation depth of the connection body in the installation opening of the wall. This fastening ring has at least one bayonet claw projecting radially inwards. On the rear side, four pipe unions are inserted radially and at right angles to one another in the connection body, as also shown in the figures. These pipe unions can be connected to water pipes laid in the wall.

In EP 2 143 846 B1, a mounting device for a flush-mounted box for sanitary installations is proposed, in which the fastening ring consists of two rigid flange parts that are joined together during assembly. This makes it somewhat easier to mount the box on the wall, because the two flange parts can be slid on from the side, and are then held together by latching hooks in the closed position. According to the figures, the fitting connecting pieces used here have radially protruding pipe unions arranged at right angles to one another.

EP 2 853 643 A1 describes a connection body for a sanitary flush-mounted fitting. An adjustable fastening device allows the connection body to be fastened at different installation depths. A fastening ring made of elastically flexible material is used here, which can be opened at an interruption point and elastically expanded so that it can be pushed onto the housing circumference of the connection body from the side, and the two ends are then guided over each other and fixed to each other. As can also be seen from the figures, the fitting connecting piece has four radial connection pieces for water pipes arranged at right angles to one another.

The basic units known from the prior art have in common that, although some suggestions have been made for easier installation of the flush-mounted boxes, the pipe unions for the water lines are always arranged radially fixed on the fitting connecting pieces. The latter means that the water lines in the wall must be aligned precisely with these fixed points in each case, which can be difficult when laying and connecting the water lines. Some detours have to be accepted when routing the lines, and mechanical stresses may remain in the installation after the water pipes have been connected.

It is the object of the present invention to provide an alternative fitting connecting piece which facilitates the connection of water lines.

This object is solved by a fitting connecting piece with the features of claim 1.

The invention further includes uses of the fitting connecting piece according to the invention.

Preferred embodiments and variants according to the invention are derived from the respective dependent claims.

A fitting connecting piece according to the invention comprises a main body with pipe unions for water lines and a main body area with mating surfaces for a functional unit, wherein each pipe union is connected by channels in the interior of the main body to a respective associated opening in a mating surface, and a functional unit with complementarily arranged openings can be mounted on the main body area with the mating surfaces, wherein the pipe unions are movably mounted in or on the main body.

In one embodiment of a fitting connecting piece according to the invention, the pipe unions are designed to pivot with joints. Preferably, the joints of the pipe unions in the fitting connecting piece according to the invention are pivot joints.

Preferably, in the fitting connecting piece according to the invention, the pivot joints are arranged in or on the main body around the main body area with the mating surfaces, wherein the connecting pieces first lead perpendicularly away from the main body and are then bent at a right angle.

In one embodiment of the fitting connecting piece according to the invention, the main body has a substantially quadrangular outline, with four pipe unions arranged in the corner regions and the main body area with the mating surfaces being located in the central area of the outline.

In a fitting connecting piece according to the invention, pipe unions with a pivot joint have a rotation range preferably of up to 120 angular degrees, particularly preferably of up to 90 angular degrees.

In another embodiment of the fitting connecting piece according to the invention, the pipe unions are designed to be pivotable with a ball joint, preferably by up to 90 angular degrees.

In the fitting connecting piece according to the invention, the main body with the pipe unions is preferably made of brass, gunmetal or stainless steel.

The present invention also includes the use of a fitting connecting piece for sanitary installations according to the invention.

In this use, the sanitary installations preferably include a cold-water connection and a hot-water connection on the respective pipe unions of the fitting connecting piece, as well as one, two or more outlets on corresponding pipe unions for mixed water, which is provided by a functional unit with mixing valve mounted on the main body area with the mating surfaces of the fitting connecting piece.

Such sanitary installations are preferably used for flush-mounted sanitary installations in bathrooms for showers and/or bathtubs.

It should be noted that a functional unit can be mounted either directly or, optionally, with an interposed adapter plate on a fitting connecting piece according to the invention. By means of an adapter plate, a possibly mismatching hole arrangement of the openings between the mating surfaces of the fitting connecting piece and a functional unit could be bridged.

In a special embodiment of the invention, a fitting connecting piece with movable pipe unions according to the invention could also be integrally formed together with a functional unit.

In the following, the invention will be explained in more detail with reference to schematic figures which illustrate examples without limiting the scope of the present invention, wherein:

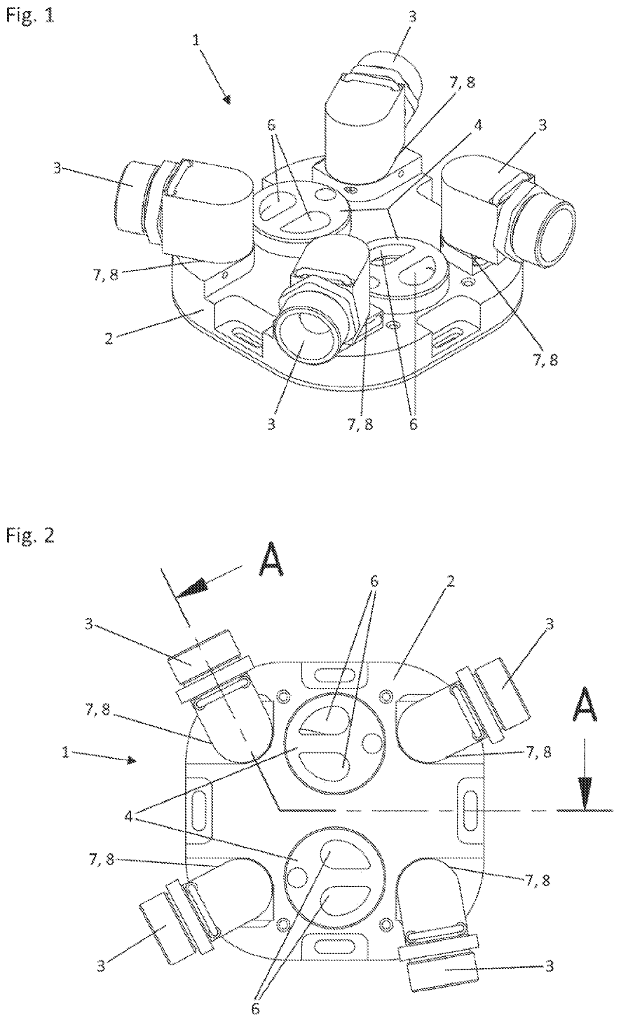

FIG. 1 shows a perspective view of a fitting connecting piece according to the invention;

FIG. 2 shows a top view (outline) of a fitting connecting piece according to the invention;

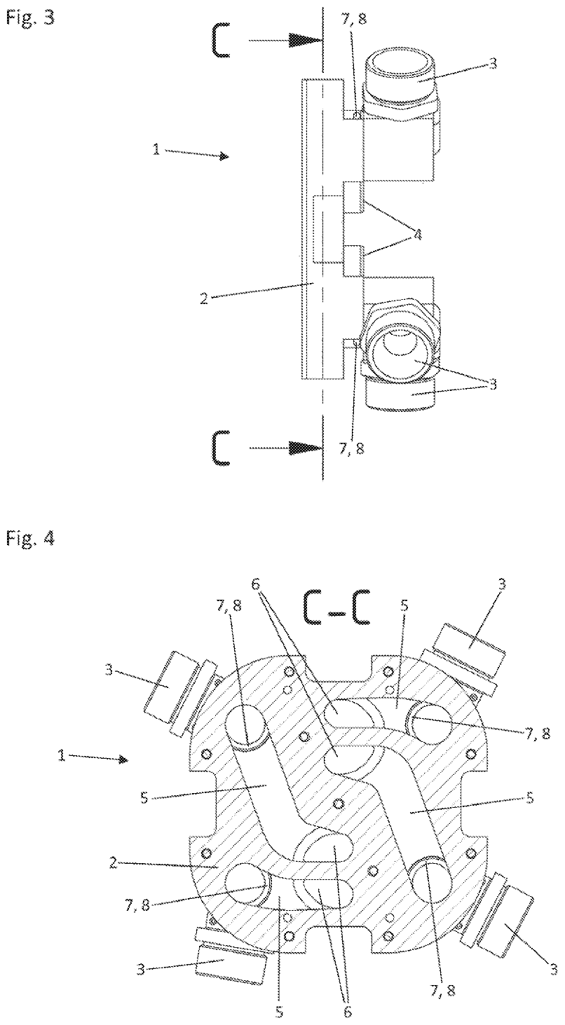

FIG. 3 shows a side view of a fitting connecting piece according to the invention;

FIG. 4 shows a fitting connecting piece according to the invention with a view of a section in the plane C-C (cf. FIG. 3);

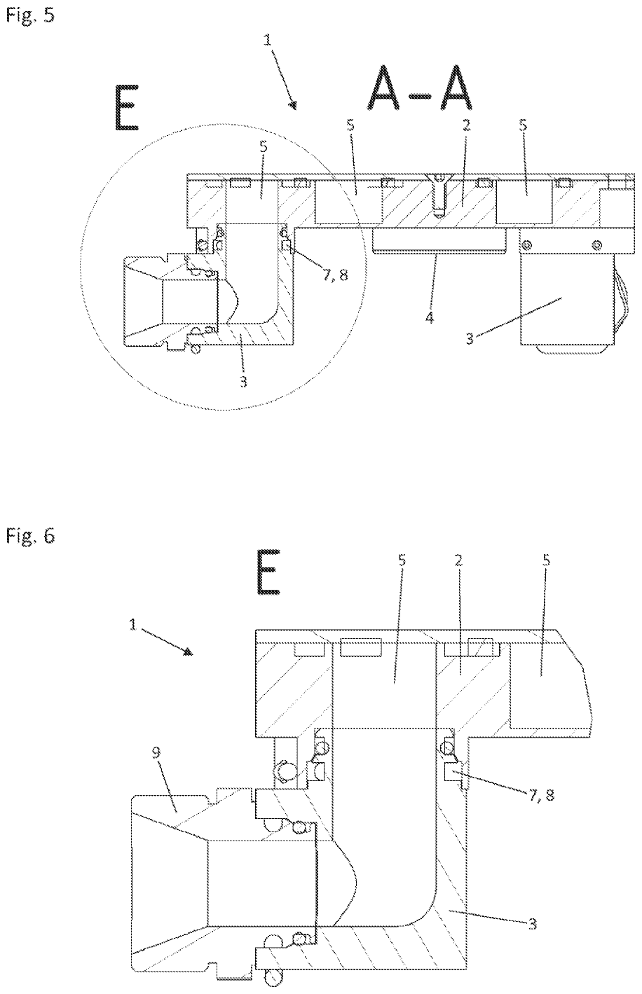

FIG. 5 shows a fitting connecting piece according to the invention in a cross-sectional profile through sectional planes A-A (cf. FIG. 2);

FIG. 6 shows an enlarged section E from FIG. 5 with a pivoting pipe union on the main body.

FIG. 1 shows a perspective view of a fitting connecting piece 1 according to the invention. An embodiment with four pipe unions 3 is shown, which are pivotably mounted in the main body 2 by means of pivot joints 7, 8. In the mating surfaces 4, the openings 6 are visible, which are connected to the pipe unions 3 inside the main body 2. The mating surfaces 4 with the openings 6 are formed here as elevations. One elevation with two openings 6 corresponds to the two inlets for hot water and cold water, and the other elevation includes two openings 6 corresponding to two mixed water outlets. A functional unit with complementarily arranged openings would be mountable on the main body area with the mating surfaces 4.

FIG. 2 shows a top view of the fitting connecting piece 1 of FIG. 1 according to the invention. In the top view, the essentially quadrangular outline of the main body 2 in this embodiment can be seen well, with the corners being rounded. In this view, the preferred rotation range of up to 90 angular degrees for the pipe unions 3 is also clearly visible. It is also evident that in this embodiment the main body area with the mating surfaces 4 is located in the central field of the outline, between the four pipe unions 3 arranged in the corner areas.

FIG. 3 shows a side view of the fitting connecting piece 1 according to the invention of the preceding figures. In the side view, on the one hand, the pivot joints 7, 8 arranged around the main body area with the mating surfaces 4 can be seen clearly, and also the pipe unions 3 initially leading away vertically from the main body 2, which are then bent at a right angle.

FIG. 4 allows a view into the interior of the main body 2 and shows a fitting connecting piece 1 according to the invention with a view of a section in the plane C-C (cf. FIG. 3). In this section, the channels 5 can be seen which, in the interior of the main body 2, connect each pipe union 3 to a respective associated opening 6 in a mating surface 4. The main body area with the mating surfaces 4 is hidden in this view, but one can see the openings 6 as well as the pivot joints 7, 8 of the pipe unions 3 from below, so to speak.

FIG. 5 shows the fitting connecting piece 1 of the previous figures in a cross-sectional profile through the sectional planes A-A (cf. FIG. 2). Here, one can see on the one hand transversely cut channels 5 inside the main body 2, and on the other hand a pipe union 3 in an axial cross-section. The pivot joint 7, 8 mounted in or on the main body 2 is also visible.

FIG. 6 shows an enlargement of section E of FIG. 5 with the pivoting pipe union 3 on the main body 2. In addition to the pivot joint 7, 8 and certain sealing rings, a threaded connection 9 of the pipe union 3 is also clearly visible.

A water pipe can be attached to this threaded connection 9, for example with a union nut. The threaded connection 9 can either be a plugged-in part as shown or an integral part of the pipe union 3.

At this point, it should be noted that any combinations of the features described and/or shown in the figures are within the scope of the present invention as long as the combinations are not inconsistent.

As can be seen from the description and the explanations of the figures, the present invention provides an advantageous, flexible and easy-to-connect alternative solution for a fitting connecting piece.

### LIST OF REFERENCE NUMERALS

Identical reference numerals in the figures indicate corresponding features, even if not explicitly referred to in the description of the individual figures in each case.
1 Fitting connecting piece
2 Main body of the fitting connecting piece 1
3 Pipe union of the main body 2
4 Mating surfaces
5 Channel in the interior of the main body 2
6 Openings in the mating surfaces 4
7 Joint of the pipe union 3
8 Pivot joint
9 Threaded connection of the pipe union 3

1. A fitting connecting piece (1) comprising a main body (2) with pipe unions (3) for water lines and a main body area with mating surfaces (4) for a functional unit, wherein each pipe union (3) is connected by channels (5) in the interior of the main body (2) to a respective associated opening (6) in a mating surface (4) and a functional unit with complementarily arranged openings can be mounted on the main body area with the mating surfaces (4), characterized in that the pipe unions (3) are movably mounted in or on the main body (2).

2. The fitting connecting piece (1) according to claim 1, characterized in that the pipe unions (3) are designed to be pivotable by means of joints (7).

3. The fitting connecting piece (1) according to claim 2, characterized in that the joints (7) of the pipe unions (3) are pivot joints (8).

4. The fitting connecting piece (1) according to claim 3, characterized in that the pivot joints (8) are arranged in or on the main body (2) around the main body area with the mating surfaces (4), wherein the pipe unions (3) first lead away perpendicularly from the main body (2) and are then bent at a right angle.

5. The fitting connecting piece (1) according to claim 1, characterized in that the main body (2) has a substantially quadrangular outline, wherein four pipe unions (3) are arranged in the corner regions, and the main body area with the mating surfaces (4) is located in the central field of the outline.

6. The fitting connecting piece (1) according to claim 3, characterized in that the pipe unions (3) with a pivot joint (7) have a rotation range of up to 120 angular degrees, preferably of up to 90 angular degrees.

7. The fitting connecting piece (1) according to claim 2, characterized in that the pipe unions (3) are designed to be pivotable with a ball joint, preferably by up to 90 angular degrees.

8. The fitting connecting piece (1) according to claim 1, characterized in that the main body (2) with the pipe unions (3) is made of brass, gunmetal or stainless steel.

9. A sanitary installation comprising the fitting connecting piece (1) according to claim 1.

10. The sanitary installation according to claim 9, said sanitary installation comprising a cold-water connection and a hot-water connection to the respective pipe union (3) of the fitting connecting piece (1), as well as one, two or more outlets to respective pipe unions (3) for mixed water provided by a functional unit with mixing valve mounted on the main body area with the mating surfaces (4) of the fitting connecting piece (1).

11. The sanitary installation according to claim 9, wherein the sanitary installation is a flush mounted sanitary installation for showers and/or bathtubs.
